(19) United States
(12) Patent Application Publication
(10) Pub. No.: US 2024/0346182 A1
(43) Pub. Date: Oct. 17, 2024

(54) METHOD, APPARATUS, ELECTRONIC DEVICE AND STORAGE MEDIUM FOR PERMISSION SYNCHRONIZATION

(71) Applicant: Beijing Bytedance Network Technology Co., Ltd., Beijing (CN)

(72) Inventors: Shide JIANG, Beijing (CN); Jing LI, Beijing (CN)

(21) Appl. No.: 18/294,761

(22) PCT Filed: Jul. 7, 2022
(86) PCT No.: PCT/CN2022/104353

§ 371 Date: Feb. 2, 2024

(30) Foreign Application Priority Data
Sep. 8, 2021 (CN) 202111046737.3

(51) Int. Cl. G06F 21/62

(52) U.S. Cl. CPC G06F 21/629

(57) ABSTRACT

The disclosure provides a method, apparatus, electronic device and storage medium for permission synchronization. In the method, a set of first permission information to be synchronized from a second operating system running on a first operating system environment is obtained. The set of first permission information to be synchronized is transmitted to a shared memory area of the first operating system and the set of first permission information to be synchronized is stored in the shared memory area of the first operating system. Permission information is read from the shared memory area by the first operating system.

The present disclosure claims priority to the Chinese Patent Application No. 202111046737.3, filed on Sep. 8, 2021, the entirety of which is incorporated herein by reference.

### FIELD

The present disclosure relates to the field of computer operating system technology, for example, to a method, apparatus, electronic device and storage medium for permission synchronization.

### BACKGROUND

Android® is an operating system (OS) based on Linux® kernel. In order to expand the application ecosystem of Linux® OS release, Android® applications can be run in Linux OS through virtual machines, containers, etc.

### SUMMARY

The present disclosure provides a method, device, electronic device, and storage medium for permission synchronization.

A method for permission synchronization is provided by the present disclosure. In the method, a set of first permission information to be synchronized from a second operating system running on a first operating system environment is obtained. The set of first permission information to be synchronized is transmitted to a shared memory area of the first operating system and the set of first permission information to be synchronized is stored in the shared memory area of the first operating system. Permission information is read from the shared memory area by the first operating system.

An apparatus for permission synchronization is provided by the present disclosure. The apparatus comprises: a permission information obtaining module configured for obtaining a set of first permission information to be synchronized from a second operating system running on a first operating system environment: a permission information transmitting and storing module configured for transmitting the set of first permission information to be synchronized to a shared memory area of the first operating system and storing the set of first permission information to be synchronized in the shared memory area of the first operating system: and a permission information reading module configured for, the first operating system reading permission information from the shared memory area.

An electronic device is provided by the present disclosure. The electronic device comprises a memory, a processor, and a computer program stored in and executable on the processor, when the processor executes the program, the processor implements steps of the method for permission synchronization.

A non-transitory computer-readable storage medium is provided by the present disclosure. The non-transitory computer-readable storage medium has a computer program stored thereon which, when executed by a processor, implements steps of the method for permission synchronization.

### BRIEF DESCRIPTION OF THE DRAWINGS

The following will be a brief introduction to the accompanying drawings required for the description of embodiments or related technologies, the accompanying drawings in the following description are some embodiments of the present disclosure. For those of ordinary skill in the art, other drawings can be obtained based on these drawings without creative labor.

FIG. 1 is a flowchart of the method for permission synchronization of the present disclosure:

FIG. 2 is a schematic diagram of the implementation of the method for permission synchronization provided by the present disclosure in an embodiment:

FIG. 3 is a schematic diagram of the apparatus for permission synchronization provided by the present disclosure: and

FIG. 4 is a schematic structural diagram of the of the electronic device provided by the present disclosure.

### DETAILED DESCRIPTION

The technical solution in the present disclosure will be described below with reference to the drawings in the present disclosure, and the described embodiments are part of the embodiments of the present disclosure, but not all of the embodiments. Based on the embodiments in the present disclosure, all other embodiments obtained by persons of ordinary skill in the art without creative efforts fall within the protection scope of the present disclosure.

It is feasible to implement Linux® OS, Windows®, etc. supporting applications in Android® OS through virtual machines and containers. Mobile operating systems, such as Android®, IOS®, etc., implement permission management for applications and system functions, which does not exist in traditional desktop operating systems. To achieve better support mobile applications and prevent them from interfering with the functions of the host operating system or maliciously using permissions, it is necessary to be compatible with the permissions and attributes of mobile applications on the desktop.

At the same time, it is also feasible to run a virtual Android® system in a host Android® system, such as virtual memory operating system (VMOS), lightspeed virtual machine and other schemes, all of which have realized the running the virtual Android® OS in the host Android® OS. In such technical solutions. there is also a problem of the host operating system being unable to be obtained and manage permissions in virtual Android® systems.

In an optional technical solution, one way is to develop a specialized cross-system permission attribute management function in the host operating system and set permissions for each application and system function on the host end and mobile end respectively. However, this way not only has a high pressure of development, but also brings a great burden to users, which is too cumbersome and prone to conflicts in permission settings caused by negligence.

In the following embodiments, the second operating system includes a variety of mobile operating systems having permission management for applications and functions, such as Android®. IOS®, etc. The term Android® referred to here includes Google's Android® OS and various derivatives of Android Open Source Project (AOSP), such as MIUI, EMUI and the like.

In the following embodiments. the first operating system includes various desktop operating systems. such as Windows®, Linux®, Mac OS®, etc., which may be a mobile operating system, such as Android®, etc.

In the following embodiments, the second operating system may runs on the first operating system environment, which may be implemented in a virtual machine manner, for example, the first operating system supports the second operating system through a virtual machine monitor (Hypervisor): which may be implemented in a Container manner to support the second operating system, in the container environment, the second operating system shares an operating system kernel with the first operating system.

For ease of explanation, in the following embodiments. the second operating system is Android®, the first operating system is Linux® OS, and Android® shares the Linux® kernel of Linux® OS in a containerized manner as an example to illustrate implementation process of the present disclosure.

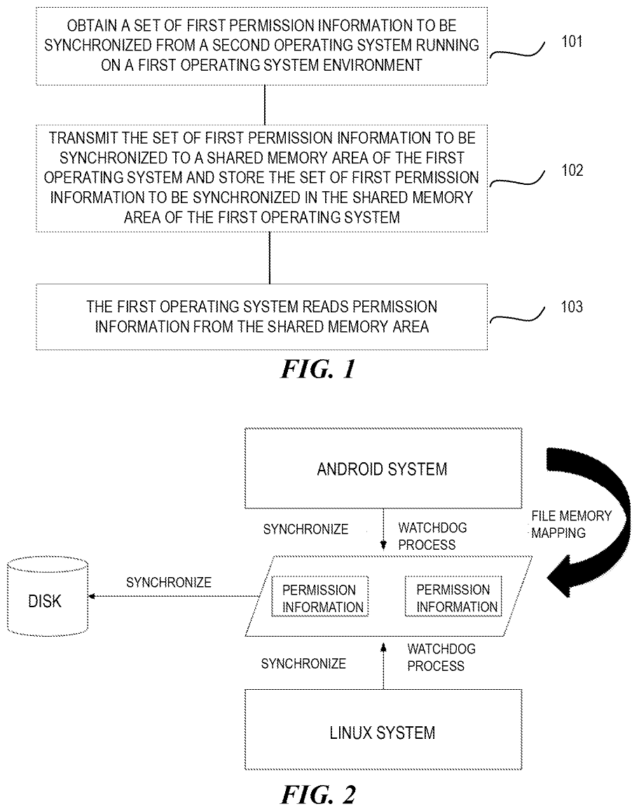

The method, device, electronic device and storage medium for permission synchronization of the present disclosure will be described below with reference to FIGS. 1-4.

FIG. 1 is a flowchart of the method for permission synchronization of the present disclosure. As shown in FIG. 1, the method for permission synchronization provided by the present disclosure includes the following steps.

At step 101, an electronic device obtains a set of first permission information to be synchronized from a second operating system running on a first operating system environment.

Permissions are used to describe whether a certain subject has access to resources in the system. For example, if an Android® application A has permissions for accessing an interface or using a certain hardware a, it means that Android® application A is allowed to access the interface or use the certain hardware a: if Android® application B does not have permissions for accessing an interface or using a certain hardware b, it means that Android® application B is prohibited from accessing the interface or using the certain hardware b.

Permission information is information used to describe permissions. In this embodiment, the permission information includes information of a permission name, information of a permission attribute, and a permission value. For example, the permission “INTERNET” is used to determine whether a certain subject can connect to the Internet, whose information of a permission name can be represented as “android, permission, INTERNET”. The information of a permission attribute is used to describe the grouping to which the permission belongs. For example, the information of permission attribute of permission “INTERNET” is “inet” (network), indicating that the permission is related to the network. The permission value is used to describe the level of the permission. The most common permission levels include “allow” and “prohibit”, which can be represented by logical values “1” and “0”: more permission levels can also be set to diversify permissions.

It can be understood that the composition of permission information is not limited to the above description, and those skilled in the art can determine the composition of permission information according to actual needs.

In the present embodiment, the permission information is set under the Android® OS or automatically set by the application system at the time of installation and stored in a specified location in the second operating system. Therefore, the permission information to be synchronized can be obtained from a specified location in the second operating system.

For example, taking the second operating system as the Android® system as an example, the following permission information for the permission “INTERNET” is set under the Android® system framework layer (framework/base/data/etc/platform.xml):

< permission name = “android.permission. INTERNET” >
< group gid = “inet” >
</permission >

The information of a permission name “android, permission. INTERNET” is stored in the “permission name” field, and the group to which the permission “INTERNET” belongs (i.e., information of a permission attribute) is stored in the “group gid” field.

The permission information will be synchronized to the first operating system in a subsequent step. Because the permission information to be synchronized may be one or more, which includes the permission information of at least one of at least one application and system functions in the second operating system, in the present embodiment, the permission information to be synchronized is referred to as the set of first permission information to be synchronized.

The type of permission information to be synchronized contained in the set of first permission information is not limited to the above example. The permission information which has been set in advance in the second operating system and is required in the first operating system can be used as the permission information to be synchronized. The type of permission information contained in the set of first permission information to be synchronized is not limited in the present embodiment.

It should be noted that, in the present embodiment, the method for permission synchronization of the present disclosure is performed during system initialization, to uniformly synchronize the relevant permissions in the second operating system to the first operating system.

At step 102, the electronic device transmits the set of first permission information to be synchronized to a shared memory area of the first operating system and stores the set of first permission information to be synchronized in the shared memory area of the first operating system.

The shared memory area means that the data stored in the memory area can be accessed by two or more processes. For example, the shared memory area of Linux® OS means that the data stored in the memory area can be accessed by two or more Linux® processes.

After obtaining the set of first permission information to be synchronized in the previous step, the information may be transmitted to the shared memory area of the first operating system and stored in the shared memory area of the first operating system in this step.

Due to the isolation of the first operating system environment and the second operating system environment, it is necessary to use a specific way to transfer the set of first permission information from the Android® environment to the Linux® environment, such as by way of file memory mapping (map files or device into memory, mmap), by way of socket service, by way of pipe, by way of named pipe (FIFO), by way of message queue, by way of semaphore, by way of signal, etc. The way of obtaining and transmitting the information to be synchronized is not limited in this embodiment.

It should be noted that mmap is a method of file memory mapping, which can map a file or other objects into a memory.

At step 103, the first operating system reads permission information from the shared memory area.

For example, a predetermined process, application, etc. in the Linux® OS can freely access the shared memory area of the first operating system. When a Linux® process or application needs to obtain permission information, the permission information can be searched in the shared memory area of the first operating system firstly. If the shared memory area stores the permission information required by the Linux® process or application, it can be read from the shared memory area.

For example, the permission information of permission “INTERNET” is transmitted to a shared memory area of the Linux® system and stored in the shared memory area of the Linux® system, and it is referenced and managed by a linked list in the shared memory area: when a Linux® process or application requires the permission information, its reference is obtained by looking up the linked list, and the memory address where the real data is located is obtained, thereby obtaining the final real data.

In the method for permission synchronization provided by the present disclosure, the set of first permission information in the second operating system is transmitted to the shared memory area of the first operating system, so that the first operating system can read the permission information from the shared memory area when needed, thereby realizing the fast synchronization of the permission information and avoiding the problem of low efficiency caused by resetting the permission information in the first operating system. Based on any of the above embodiments, in the present embodiment, the transmitting the set of first permission information to be synchronized to a shared memory area of the first operating system and storing the set of first permission information to be synchronized in the shared memory area of the first operating system comprises: transmitting, by mmap mapping, the set of first permission information to be synchronized to the shared memory area of the first operating system and storing the set of first permission information to be synchronized in the shared memory area of the first operating system.

Processes are enabled by mmap to share memory by mapping the same file. After the file is mapped to a process address space, the process can access the file like accessing normal memory.

For example, the set of first permission information is read from the Android® system framework layer, and then synchronized to the Linux® kernel space of the first operating system by way of process space accessing (mmap). Due to the characteristics of mmap itself, only one copy operation needs to be done when synchronizing permission information, which helps to improve the efficiency of synchronizing permission information from the Android® system to the Linux® system.

In the method for permission synchronization provided by the present disclosure, the set of first permission information to be synchronized is transmitted to the shared memory area of the first operating system by mmap mapping and stored in shared memory area of the first operating system. Based on the characteristics of mmap mapping itself, this way can improve the efficiency of synchronizing permission information from the second operating system to the first operating system.

Based on any of the above embodiments, in the present embodiment, the transmitting the set of first permission information to be synchronized to a shared memory area of the first operating system and storing the set of first permission information to be synchronized in the shared memory area of the first operating system comprises: establishing a socket connection between the first operating system and the second operating system: and transmitting, by the socket connection, the set of first permission information to be synchronized to the shared memory area of the first operating system and storing the set of first permission information to be synchronized in the shared memory area of the first operating system.

Socket is used for bidirectional communication between application processes on different hosts in the network. In the present embodiment, the socket can also be applied to the communication between the second operating system and the first operating system. For example, a socket connection can be initiated by the first operating system, and the second operating system acts as a client link to the socket connection initiated by the first operating system, thereby establishing a bidirectional communication between the first operating system and the second operating system. Then, the set of the first permission information to be synchronized can be transmitted to the shared memory area of the first operating system with the socket connection and stored in the shared memory area of the first operating system.

In a subsequent operation, if the first operating system needs to control the permission information of the second operating system, the socket connection can be used to send instructions directly at the Linux® end, rather than forcing the instruction must be sent at the Android® end.

In the method for permission synchronization provided by this disclosure, the set of first permission information to be synchronized is transmitted to the shared memory area of the first operating system by a socket connection and stored in the shared memory area of the first operating system, which makes the synchronization process of the permission information more flexible.

Based on any of the above embodiments, in the present embodiment, after transmitting the set of first permission information to be synchronized to a shared memory area of the first operating system and storing the set of first permission information to be synchronized in the shared memory area of the first operating system, the method further comprises: setting a first monitoring process in the second operating system, wherein the first monitoring process is configured to monitor the shared memory area: and if the permission information stored in the shared memory area changes, obtaining a set of second permission information to be synchronized from the second operating system, transmitting the set of second permission information to be synchronized to the shared memory area of the first operating system and storing the set of second permission information to be synchronized in the shared memory area of the first operating system.

In the previous embodiment, the synchronization of the permission information is generally implemented when the system is started. However, during the operation of the system, there is a case where the permission information is changed. In the present embodiment, such cases are discussed.

Taking Android® as an example, the first monitoring process can be customized in the Android® system, and the first monitoring process can be implemented by using a WatchDog process. When the Android® system is started, the first monitoring process can start by itself to realize the monitoring of the shared memory area.

The monitoring of the shared memory area by the first monitoring process is mainly to monitor the identification information in the shared memory area, and the identification information can reflect whether the permission information stored in the shared memory area changes. For example, if a certain permission information does not change after being stored in the shared memory area, the value of the identification information corresponding to the permission information is “0”: and then, if the permission information changes, the value of the identification information corresponding to the permission information changes from “0” to “1”. There is a corresponding relationship between the identification information and the permission information, for example, each permission information has a unique corresponding identification information. Since the type of permission information to be synchronized is not limited to one, the type of identification information set in the shared memory area is not limited to one.

If the first monitoring process finds that the permission information has changed by monitoring the identification information, it can re-obtain the permission information to be synchronized from the second operating system and transmit it to the shared memory area of the first operating system and store it in the shared memory area of the first operating system. It should be noted that the information to be synchronized here can be the changed permission information determined by the changed identification information, or all the permission information previously stored in the shared memory area of the first operating system. In order to distinguish the permission information to be synchronized here from the permission information synchronized during system initialization, in this embodiment, the permission information to be synchronized here is referred to as the set of second permission information to be synchronized. The set of second permission information may include one or more permission information to be synchronized.

It should be noted that the change of the permission information described in the present embodiment may be that the user changes the permission information in the second operating system, for example, a certain function of the second operating system applies for network permission: may also be that the user in the first operating system sends an instruction to change the permission information in the second operating system. No matter what causes the permission information to change, the changed permission information can be synchronized to the shared memory area of the first operating system, so that the process in the first operating system can obtain the updated permission information in time.

In the method for permission synchronization provided by the present disclosure, the shared memory area of the first operating system can be monitored by initiating the first monitoring process in the second operating system, so that when the permission information changes, it can be found in time to avoid data risks caused by failure to synchronize permission information in time.

Based on any of the above embodiments, in the present embodiment, after transmitting the set of first permission information to be synchronized to a shared memory area of the first operating system and storing the set of first permission information to be synchronized in the shared memory area of the first operating system, the method further comprises: setting a second monitoring process in the first operating system, wherein the second monitoring process is configured to monitor the shared memory area: and if the permission information stored in the shared memory area changes, obtaining a set of second permission information to be synchronized from the second operating system, transmitting the set of second permission information to be synchronized to the shared memory area of the first operating system and storing the set of second permission information to be synchronized in the shared memory area of the first operating system.

In the previous embodiments, the synchronization of the permission information is generally implemented during system initialization. However, in the actual application process, there is a case where the permission information is changed.

Taking Linux® OS as an example, the second process can be started by an init process in the Linux® system. and the second monitoring process can be realized by the WatchDog process. The init process is the starting point of all processes in the system.

The monitoring of the shared memory area by the second monitoring process is mainly to monitor the identification information in the shared memory area, and the identification information can reflect whether the permission information stored in the shared memory area has changed. For example, if a certain permission information does not change after being stored in the shared memory area, the value of the identification information corresponding to the permission information is “0”; and then, if the permission information changes, the value of the identification information corresponding to the permission information changes from “0” to “1”. There is a corresponding relationship between the identification information and the permission information, for example, each permission information has a unique corresponding identification information. Since the type of permission information to be synchronized is not limited to one, the type of identification information set in the shared memory area is not limited to one.

If the second monitoring process finds that the permission information has changed by monitoring the identification information, it can re-obtain the permission information to be synchronized from the second operating system and transmit it to the shared memory area of the first operating system and store it in the shared memory area of the first operating system. It should be noted that the information to be synchronized here can be the changed permission information determined by the changed identification information, or all the permission information previously stored in the shared memory area of the first operating system. In order to distinguish the permission information to be synchronized here from the permission information synchronized during system initialization, in this embodiment, the permission information to be synchronized here is referred to as the set of second permission information to be synchronized. The set of second permission information may include one or more permission information to be synchronized.

In the method for permission synchronization provided by the present disclosure, the shared memory area of the first operating system can be monitored by initiating the second monitoring process in the first operating system, so that when the permission information changes, it can be found in time to avoid data risks caused by failure to synchronize permission information in time.

Based on any of the above embodiments, in the present embodiment, after transmitting the set of first permission information to be synchronized to a shared memory area of the first operating system and storing the set of first permission information to be synchronized in the shared memory area of the first operating system, the method further comprises: writing the set of first permission information into a storage device.

In the present embodiment, after the set of first permission information is stored in the shared memory area, the set of first permission information is also written to the storage device.

Information stored in memory will disappear after the computing device is powered off. In order to achieve local permanent storage of synchronized permission information, in the present embodiment, the set of first permission information is written to the storage device.

After the computing device is restarted, the set of first permission information is read from the local storage device first, without waiting for permission synchronization before setting the permission information, which improves work efficiency.

Based on any of the above embodiments, in the present embodiment, the writing the set of first permission information into a storage device comprises: inspecting predetermined first flag information, wherein the first flag information corresponds to a first permission information in the set of first permission information, and the first permission information is any permission information in the set of first permission information: if the first flag information is a first state value, writing the first permission information into the storage device in real time: and if the first flag information is a second state value, after a selected delay, writing the first permission information into the storage device.

In the present embodiment, the timing for writing any permission information in the first set of rights information to the disk is specified. Therefore, the corresponding flag information may be set in advance for respective permission information in the set first of permission information, and the flag information can reflect the urgency of the corresponding permission information written to the disk.

If the first permission information in the set of first permission information is very important and urgent, the first flag information can be set to the first state value. When it is inspected that the first flag information is the first status value, once the first permission information is written into the shared memory area of the first operating system, the first permission information needs to be synchronized to the storage device in real time. This ensures the timely preservation of important permission information and effectively avoids the risk of sudden failures.

If the first permission information is relatively unimportant or less urgent, the first flag information can be set to the second state value. When it is inspected that the first flag information is the second state value, after the first permission information is written into the shared memory area of the first operating system it is allowed to experience a certain delay, such as setting it to 30 seconds(s) 1 minute (min), etc., and then synchronize the first permission information to the storage device. Generally speaking, the storage of the first permission information in the storage device can be implemented when the first operating system is relatively idle, thereby reducing the number of frequent interruptions of the first operating system due to operations related to storing permission information.

The time delay described in the present embodiment may be determined according to actual needs, the value of the time delay is not limited in the present embodiment.

The first state value and the second state value may be determined according to actual needs. For example, the first state value is set to 0, the second state value is set to 1 or other candidate values, in the present embodiment, the first state value and the second state value are not limited.

In the method for permission synchronization provided by this disclosure, the timing for synchronizing the permission information from the shared memory area to the storage device is determined by inspecting the predetermined flag information, so that the timing of synchronization can be determined according to the importance of the permission information, and a balance between data security and work efficiency is achieved.

Based on any of the above embodiments, in the present embodiment, after obtaining a set of second permission information to be synchronized from the second operating system, transmitting the set of second permission information to be synchronized to the shared memory area of the first operating system and storing the set of second permission information to be synchronized in the shared memory area of the first operating system, the method further comprises: writing the set of second permission information into the storage device.

During the operation of the system, after the permission information changes in real time, the set of second permission information is also transmitted to the shared memory area of the first operating system and stored in the shared memory area of the first operating system. In the present embodiment, the set of second permission information needs to be written to the storage device to achieve local permanent storage of permission information in the set of second permission information.

The process of writing the set of second permission information to the storage device has no essential difference from the process of writing the set of first permission information to the disk, so it is not repeated here.

In the method for permission synchronization provided by the present disclosure, the set of second permission information can be preferentially read from the local disk after the computing device is restarted, without waiting for the Android® permission synchronization before setting the permission information, which improves work efficiency.

In embodiments of the present disclosure, the storage device may be a local disk, such as hard disk drive (HDD), solid state drive (SSD), etc., may also be an external storage device, such as U disk, SD card, etc., may also be a network storage device, such as a LAN network attached storage (NAS), cloud storage, etc.

Taking the first operating system as Linux® OS and the second operating system as Android® as an example, FIG. 2 is a schematic diagram of the implementation of the method for permission synchronization provided by the present disclosure in an embodiment. Referring to FIG. 2, in this embodiment, mmap mapping can be used to synchronize the permissions and attributes related to the Android® platform to the shared memory area of Linux® so that Linux® processes can quickly access ordinary memory. For example, it may include the following steps.

At S1, the Android®-related permissions and attributes are mapped to an area of a shared memory by mmap firstly: if necessary, synchronized to the disk, so that the system can handle the status when the system is pulled up. At the same time, the Android® side starts a WatchDog process to pay attention to changes in the shared memory. When there are changes, relevant event scheduling adjustments will be made for the permissions related to the changes, so as to achieve the synchronization ability of the Linux® system to control and change the Android® system.

At S2, a Linux® process can read the relevant permission data from the shared memory area for synchronous processing by reading the memory ordinarily. If it is necessary to start a separate WatchDog process to adjust the event scheduling when the shared memory changes, the ability of real-time monitoring for Android® permission change by the Linux® system can be achieved.

At S3, when data is written to the shared memory, in embodiments of the present disclosure, it can be determined whether it is necessary to synchronize the disk in real time by a flag or synchronize data to the disk according to a certain timing, such as before the process is shut, etc., which is convenient for reading some permissions locally when the system startup in the next time.

In another embodiment, the method for permission synchronization provided by the present disclosure can also be implemented by socket. For example, it may include the following steps.

At S11, the Android® platform related permissions and attributes are synchronized to the Linux® shared memory area by socket.

At S12, Linux® end starts a socket service, and Android® end acts as a client to connect the socket service initialized by the Linux® end, and then the relevant permissions and attributes are synchronized to the Linux® end by socket and written to the shared memory, which can be obtained by relevant processes of the Linux® end.

At S13, after the Linux® synchronizes the permissions of the Android® end, if relevant permission control operations are required, relevant control requests may be sent to the Android® end by sockets.

The following describes the apparatus for permission synchronization provided by the present disclosure, and the apparatus for permission synchronization described below and the method for permission synchronization described above can be referred to in correspondence.

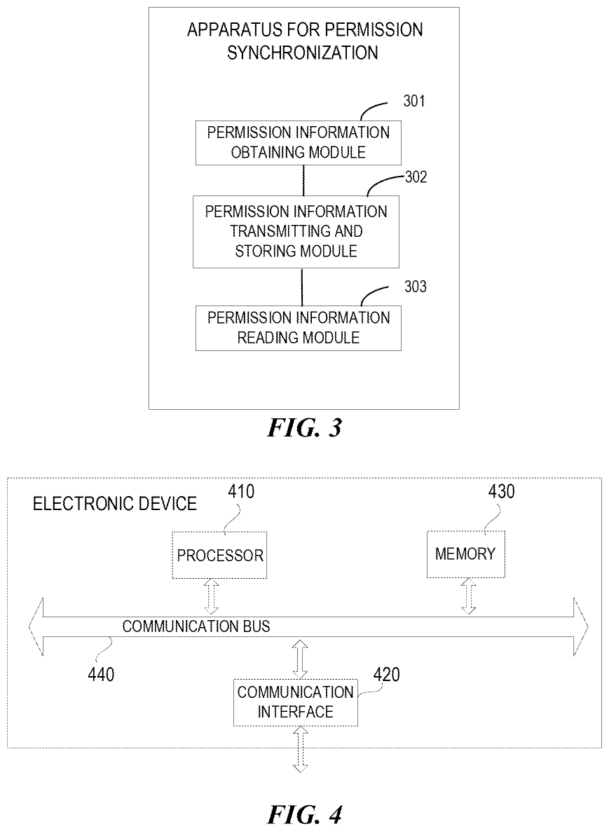

FIG. 3 is a schematic diagram of the apparatus for permission synchronization provided by the present disclosure. As shown in FIG. 3, the apparatus for permission synchronization provided by the present disclosure includes: a permission information obtaining module 301 configured for obtaining a set of first permission information to be synchronized from a second operating system running on a first operating system environment: a permission information transmitting and storing module 302 configured for transmitting the set of first permission information to be synchronized to a shared memory area of the first operating system and storing the set of first permission information to be synchronized in the shared memory area of the first operating system: and a permission information reading module 303 configured for, the first operating system reading permission information from the shared memory area.

In the apparatus for permission synchronization provided by the present disclosure, the set of first permission information in the second operating system is transmitted to the shared memory area of the first operating system, so that the first operating system can read the permission information from the shared memory area when needed, thereby realizing the fast synchronization of the permission information and avoiding the problem of low efficiency caused by resetting the permission information in the first operating system.

Based on any of the above embodiments, in the present embodiment, the permission information transmitting and storing module 302 is configured for: transmitting, by mmap mapping, the set of first permission information to be synchronized to the shared memory area of the first operating system and storing the set of first permission information to be synchronized in the shared memory area of the first operating system.

In the apparatus for permission synchronization provided by the present disclosure, the set of first permission information to be synchronized is transmitted to the shared memory area of the first operating system by mmap mapping and stored in shared memory area of the first operating system. Based on the characteristics of mmap mapping itself, this way can improve the efficiency of synchronizing permission information from the second operating system to the first operating system.

Based on any of the above embodiments, in the present embodiment, the permission information transmitting and storing module 302 is configured for: establishing a socket connection between the first operating system and the second operating system: and transmitting, by the socket connection, the set of first permission information to be synchronized to the shared memory area of the first operating system and storing the set of first permission information to be synchronized in the shared memory area of the first operating system.

In the apparatus for permission synchronization provided by the present disclosure, the set of first permission information to be synchronized is transmitted to the shared memory area of the first operating system by a socket connection and stored in the shared memory area of the first operating system, which makes the synchronization process of the permission information more flexible.

Based on any of the above embodiments, in the present embodiment, the apparatus further comprises: a first monitoring module configured for initiating a first monitoring process in the second operating system, wherein the first monitoring process is configured to monitor the shared memory area: and a second transmitting and storing module configured for, if the permission information stored in the shared memory area changes, obtaining a set of second permission information to be synchronized from the second operating system, transmitting the set of second permission information to be synchronized to the shared memory area of the first operating system and storing the set of second permission information to be synchronized in the shared memory area of the first operating system.

In the apparatus for permission synchronization provided by the present disclosure, the shared memory area of the first operating system can be monitored by initiating the first monitoring process in the second operating system, so that when the permission information changes, it can be found in time to avoid data risks caused by failure to synchronize permission information in time.

Based on any of the above embodiments, in the present embodiment, the apparatus further comprises: a second monitoring module configured for initiating a second monitoring process in the first operating system, wherein the second monitoring process is configured to monitor the shared memory area; and a second transmitting and storing module configured for, if the permission information stored in the shared memory area changes, obtaining a set of second permission information to be synchronized from the second operating system, transmitting the set of second permission information to be synchronized to the shared memory area of the first operating system and storing the set of second permission information to be synchronized in the shared memory area of the first operating system.

In the apparatus for permission synchronization provided by the present disclosure, the shared memory area of the first operating system can be monitored by initiating the second monitoring process in the first operating system, so that when the permission information changes, it can be found in time to avoid data risks caused by failure to synchronize permission information in time.

Based on any of the above embodiments, in the present embodiment, the apparatus further comprises: a first writing module configured for writing the set of first permission information into a storage device.

In the apparatus for permission synchronization provided by the present disclosure, after the computing device is restarted, the set of first permission information is read from the local storage device first, without waiting for permission synchronization before setting the permission information, which improves work efficiency.

Based on any of the above embodiments, in the present embodiment, the first writing module comprises: a flag information inspecting unit configured for inspecting predetermined first flag information, wherein the first flag information corresponds to a first permission information in the set of first permission information, and the first permission information is any permission information in the set of first permission information: a real-time writing unit configured for, if the first flag information is a first state value, writing the first permission information into the storage device in real time: and a delay writing unit is configured for, if the first flag information is a second state value, after a selected delay, writing the first permission information into the storage device.

In the apparatus for permission synchronization provided by the present disclosure, the timing for synchronizing the permission information from the shared memory area to the storage device is determined by inspecting the predetermined flag information, so that the timing of synchronization can be determined according to the importance of the permission information, and a balance between data security and work efficiency is achieved.

Based on any of the above embodiments, in the present embodiment, the apparatus further comprises: a second writing module configured for writing the set of second permission information into the storage device.

In the apparatus for permission synchronization provided by the present disclosure, the set of second permission information can be preferentially read from the local disk after the computing device is restarted, without waiting for the Android® permission synchronization before setting the permission information, which improves work efficiency.

FIG. 4 illustrates a schematic diagram of the entity structure of an electronic device. As shown in FIG. 4, the electronic device may include: a processor 410, a communication interface 420, a memory 430, and a communication bus 440. The processor 410, the communication interface 420, and the memory 430 communicate with each other through the communication bus 440. The processor 410 can call logical instructions in the memory 430 to execute the method for permission synchronization. In the method, a set of first permission information to be synchronized from a second operating system running on a first operating system environment is obtained. The set of first permission information to be synchronized is transmitted to a shared memory area of the first operating system and the set of first permission information to be synchronized is stored in the shared memory area of the first operating system. Permission information is read from the shared memory area by the first operating system.

In addition, the logical instructions in the memory 430 can be implemented in the form of software functional units and can be stored in a computer-readable storage medium when sold or used as an independent product. Based on this understanding, the essence of the technical solution of the present disclosure or the part that contributes to the related technology or the part of the technical solution can be embodied in the form of a software product, which is stored in a storage medium, including at least one instruction to make a computer device (which can be a personal computer, server, or network device, etc.) execute all or part of the steps of the methods described in each embodiment of the present disclosure. The aforementioned storage medium includes: U disk, mobile hard disk, Read-Only Memory (ROM), Random Access Memory (RAM), magnetic disk or optical disk, and other medium that can store program code.

On the other hand, the present disclosure also provides a computer program product, and the computer program product comprising a computer program stored on a non-transitory computer-readable storage medium, and the computer program comprises program instructions, when the program instructions are executed by a computer, the computer can execute the method for permission synchronization provided by the above methods. In the method, a set of first permission information to be synchronized from a second operating system running on a first operating system environment is obtained. The set of first permission information to be synchronized is transmitted to a shared memory area of the first operating system and the set of first permission information to be synchronized is stored in the shared memory area of the first operating system. Permission information is read from the shared memory area by the first operating system.

On the other hand, the present disclosure also provides a non-transitory computer-readable storage medium, on which a computer program is stored, the computer program when executed by a processor implements the above-provided method for permission synchronization. In the method, a set of first permission information to be synchronized from a second operating system running on a first operating system environment is obtained. The set of first permission information to be synchronized is transmitted to a shared memory area of the first operating system and the set of first permission information to be synchronized is stored in the shared memory area of the first operating system. Permission information is read from the shared memory area by the first operating system.

For the beneficial effects of the electronic device, the program, and the storage medium in the embodiments of the present disclosure, reference may be made to the analysis of the beneficial effects of the above-mentioned methods, which will not be repeated here.

Apparatus embodiments described above are merely illustrative, wherein the units described as separate components may or may not be physically separated, and the components displayed as units may or may not be physical units, i.e., may be located in one place, or may be distributed to multiple network units. Some or all of the modules may be selected according to actual needs to implement the present embodiment. Those of ordinary skill in the art can understand and implement without creative labor.

Through the description of the above embodiments, those skilled in the art can clearly understand that each embodiment can be implemented by means of software and a necessary universal hardware platform. Certainly, it can also be implemented by hardware. Based on this understanding, the essence of the above technical solution or the part that contributes to the relevant technology can be embodied in the form of a software product, which can be stored in a computer-readable storage medium such as ROM, RAM, magnetic disk, optical disk, etc., including at least one instruction for enabling a computer device (which can be a personal computer, server, or network device, etc.) to execute the methods described in various embodiments or some parts of the embodiments.

1. A method for permission synchronization, comprising:
obtaining a set of first permission information to be synchronized from a second operating system running on a first operating system environment;
transmitting the set of first permission information to be synchronized to a shared memory area of the first operating system and storing the set of first permission information to be synchronized in the shared memory area of the first operating system; and
the first operating system reading permission information from the shared memory area.

2. The method for permission synchronization of claim 1, wherein the transmitting the set of first permission information to be synchronized to a shared memory area of the first operating system and storing the set of first permission information to be synchronized in the shared memory area of the first operating system comprises:
transmitting, by file memory mapping, the set of first permission information to be synchronized to the shared memory area of the first operating system and storing the set of first permission information to be synchronized in the shared memory area of the first operating system.

3. The method for permission synchronization of claim 1, wherein the transmitting the set of first permission information to be synchronized to a shared memory area of the first operating system and storing the set of first permission information to be synchronized in the shared memory area of the first operating system comprises:
establishing a socket connection between the first operating system and the second operating system; and
transmitting, by the socket connection, the set of first permission information to be synchronized to the shared memory area of the first operating system and storing the set of first permission information to be synchronized in the shared memory area of the first operating system.

4. The method for permission synchronization of claim 1, after transmitting the set of first permission information to be synchronized to a shared memory area of the first operating system and storing the set of first permission information to be synchronized in the shared memory area of the first operating system, the method further comprising:
setting a first monitoring process in the second operating system, wherein the first monitoring process is configured to monitor the shared memory area; and
if the permission information stored in the shared memory area changes, obtaining a set of second permission information to be synchronized from the second operating system, transmitting the set of second permission information to be synchronized to the shared memory area of the first operating system and storing the set of second permission information to be synchronized in the shared memory area of the first operating system.

5. The method for permission synchronization of claim 1, after transmitting the set of first permission information to be synchronized to a shared memory area of the first operating system and storing the set of first permission information to be synchronized in the shared memory area of the first operating system, the method further comprising:
setting a second monitoring process in the first operating system, wherein the second monitoring process is configured to monitor the shared memory area; and
if the permission information stored in the shared memory area changes, obtaining a set of second permission information to be synchronized from the second operating system, transmitting the set of second permission information to be synchronized to the shared memory area of the first operating system and storing the set of second permission information to be synchronized in the shared memory area of the first operating system.

6. The method for permission synchronization of claim 1, after transmitting the set of first permission information to be synchronized to a shared memory area of the first operating system and storing the set of first permission information to be synchronized in the shared memory area of the first operating system, the method further comprising:
writing the set of first permission information into a storage device.

7. The method for permission synchronization of claim 6, wherein the writing the set of first permission information into a storage device comprises:
inspecting predetermined first flag information, wherein the first flag information corresponds to a first permission information in the set of first permission information, and the first permission information is any permission information in the set of first permission information;
if the first flag information is a first state value, writing the first permission information into the storage device in real time; and
if the first flag information is a second state value, after a selected delay, writing the first permission information into the storage device.

8. The method for permission synchronization of claim 4, after obtaining a set of second permission information to be synchronized from the second operating system, transmitting the set of second permission information to be synchronized to the shared memory area of the first operating system and storing the set of second permission information to be synchronized in the shared memory area of the first operating system, the method further comprising:
writing the set of second permission information into the storage device.

9-11. (canceled)

12. The method for permission synchronization of claim 1, wherein the first operating system comprises a plurality of desktop operating systems.

13. The method for permission synchronization of claim 1, wherein data store in the shared memory area of the first operating system is accessed by two or more processes.

14. An electronic device comprising a memory, a processor, and a computer program stored in the memory and executable on the processor, when the processor executes the program, the processor implements acts comprising:
obtaining a set of first permission information to be synchronized from a second operating system running on a first operating system environment;
transmitting the set of first permission information to be synchronized to a shared memory area of the first operating system and storing the set of first permission information to be synchronized in the shared memory area of the first operating system; and
the first operating system reading permission information from the shared memory area.

15. The device of claim 14, wherein the transmitting the set of first permission information to be synchronized to a shared memory area of the first operating system and storing the set of first permission information to be synchronized in the shared memory area of the first operating system comprises:
transmitting, by file memory mapping, the set of first permission information to be synchronized to the shared memory area of the first operating system and storing the set of first permission information to be synchronized in the shared memory area of the first operating system.

16. The device of claim 14, wherein the transmitting the set of first permission information to be synchronized to a shared memory area of the first operating system and storing the set of first permission information to be synchronized in the shared memory area of the first operating system comprises:
establishing a socket connection between the first operating system and the second operating system; and
transmitting, by the socket connection, the set of first permission information to be synchronized to the shared memory area of the first operating system and storing the set of first permission information to be synchronized in the shared memory area of the first operating system.

17. The device of claim 14, after transmitting the set of first permission information to be synchronized to a shared memory area of the first operating system and storing the set of first permission information to be synchronized in the shared memory area of the first operating system, the acts further comprising:
setting a first monitoring process in the second operating system, wherein the first monitoring process is configured to monitor the shared memory area; and
if the permission information stored in the shared memory area changes, obtaining a set of second permission information to be synchronized from the second operating system, transmitting the set of second permission information to be synchronized to the shared memory area of the first operating system and storing the set of second permission information to be synchronized in the shared memory area of the first operating system.

18. The device of claim 14, after transmitting the set of first permission information to be synchronized to a shared memory area of the first operating system and storing the set of first permission information to be synchronized in the shared memory area of the first operating system, the acts further comprising:
setting a second monitoring process in the first operating system, wherein the second monitoring process is configured to monitor the shared memory area; and
if the permission information stored in the shared memory area changes, obtaining a set of second permission information to be synchronized from the second operating system, transmitting the set of second permission information to be synchronized to the shared memory area of the first operating system and storing the set of second permission information to be synchronized in the shared memory area of the first operating system.

19. The device of claim 14, after transmitting the set of first permission information to be synchronized to a shared memory area of the first operating system and storing the set of first permission information to be synchronized in the shared memory area of the first operating system, the acts further comprising:
writing the set of first permission information into a storage device.

20. The device of claim 19, wherein the writing the set of first permission information into a storage device comprises:
inspecting predetermined first flag information, wherein the first flag information corresponds to a first permission information in the set of first permission information, and the first permission information is any permission information in the set of first permission information;
if the first flag information is a first state value, writing the first permission information into the storage device in real time; and
if the first flag information is a second state value, after a selected delay, writing the first permission information into the storage device.

21. The device of claim 17, after obtaining a set of second permission information to be synchronized from the second operating system, transmitting the set of second permission information to be synchronized to the shared memory area of the first operating system and storing the set of second permission information to be synchronized in the shared memory area of the first operating system, the acts further comprising:
writing the set of second permission information into the storage device.

22. The device of claim 14, wherein the first operating system comprises a plurality of desktop operating systems.

23. A non-transitory computer readable storage medium having a computer program stored thereon which, when executed by a processor, implements acts comprising:
obtaining a set of first permission information to be synchronized from a second operating system running on a first operating system environment;
transmitting the set of first permission information to be synchronized to a shared memory area of the first operating system and storing the set of first permission information to be synchronized in the shared memory area of the first operating system; and
the first operating system reading permission information from the shared memory area.
